(19) United States
(12) Patent Application Publication
(10) Pub. No.: US 2016/0301560 A1
(43) Pub. Date: Oct. 13, 2016

(54) SERVER AND GATEWAY FOR FILTERING PUSH NOTIFICATIONS ACCORDING TO USER PREFERENCES

(71) Applicant: CHECK POINT SOFTWARE TECHNOLOGIES LTD., Tel Aviv (IL)

(72) Inventors: DANIEL FINCHELSTEIN, Rishon Lezion (IL); Amnon PERLMUTTER, Givatayim (IL); Aviad MOR, Tel Aviv (IL); Noam ARAD, Tel Aviv (IL)

(21) Appl. No.: 15/187,811

(22) Filed: Jun. 21, 2016

Related U.S. Application Data
(63) Continuation of application No. 14/142,998, filed on Dec. 30, 2013.

(51) Int. Cl. H04L 12/24; H04W 4/20; H04L 29/08

(52) U.S. Cl. CPC H04L 41/0604; H04L 67/26; H04W 4/20; H04W 88/02

(57) ABSTRACT

A server and/or a gateway of a computer network receive a filter for filtering data items to be sent to a mobile device of a cellular network. The mobile device is notified of receipt of data items by the server only if such notification is allowed by the filter. In one embodiment, the server maintains a first queue of data items for which notification is allowed and a second queue of data items for which notification is not allowed, and the gateway periodically inspects the first queue and notifies the mobile device of receipt of new data items.

### FIELD AND BACKGROUND OF THE INVENTION

The present invention relates to communication between mobile devices and a computer network and, more particularly, to a server and a gateway that are configured to accept filters from the mobile devices that restrict the pushing of notifications to the mobile devices.

FIG. 1 illustrates the kind of system to which the present invention applies. Users of mobile devices 10 communicate, via a cellular telephony network 12, with a computer network 14 such as the Internet, and more specifically, with a server 18 of computer network 14 via a gateway 16. Server 18 pushes, to mobile devices 10 via gateway 16, notifications of the receipt of data items, such as e-mail and calendar items, that are destined to mobile devices 10, in order to notify the users of mobile devices 10 to download those data items. It sometimes is inconvenient for a user of a mobile device 10 to receive such notifications.

It would be highly advantageous to have a way for the users of mobile devices 10 to set up filters in computer network 14 that limit the notifications that are pushed from computer network 14 to mobile devices 10, for example by time, subject, sender or folder, without imposing an undue computational burden on gateway 16.

### SUMMARY OF THE INVENTION

According to the present invention there is provided a method of selectively notifying a mobile device, on a cellular network, of receipt of data items, of a computer network, that are addressed to the mobile device, the method including the steps of: (a) receiving a filter for filtering the data items; and (b) upon receiving one of the data items from the computer network, notifying the mobile device of the receipt only if the notifying is allowed by the filter.

According to the present invention there is provided a server, of a computer network that includes a gateway that couples the computer network to a cellular network, including: (a) an interface to the computer network; (b) a filter receipt module for receiving a filter associated with a mobile device of the cellular network; and (c) a filter application module for applying the filter to a data item that is received from the computer network and that is addressed to the mobile device.

According to the present invention there is provided a gateway between a cellular network and a computer network that includes a server, the gateway including: (a) an interface to the cellular network; (b) an interface to the computer network; (c) a push notification module for: (i) receiving, from the server via the interface to the computer network, an identifier of a notification queue, at the server, that is associated with a mobile device of the cellular network; (ii) periodically inspecting the notification queue via the interface to the computer network to determine whether the notification queue includes a new data item; and (iii) if the notification queue includes the new data item: sending the mobile device, via the interface to the cellular system, a notification of a presence of the new data item at the server.

According to the present invention there is provided a gateway between a cellular network and a computer network, the gateway including: (a) an interface to the cellular network; (b) an interface to the computer network; and (c) a filter receipt module for receiving a filter associated with a mobile device of the cellular network.

The basic method of the present invention is for selectively notifying a mobile device, on a cellular network, of receipt of data items of a computer network (e.g. e-mail and calendar items) that are addressed to the mobile device. A filter for filtering the data items is received, either via the cellular network, for example from the mobile device itself, or from the computer network. When one of the data items is received from the computer network, the mobile device is notified of the receipt of the data item only if such notifying is allowed by the filter.

Preferably, the filter is received by a server of the computer network. The notifying of the mobile device of the receipt of the data item is performed cooperatively by the server and by a gateway that interfaces between the computer network and the cellular network. The server maintains two queues: a first queue of the data items for which the notifying is allowed by the filter, and a second queue of the data items for which the notifying is not allowed by the filter. (The user of the mobile device needs to explicitly interrogate the server to find out what if anything is in the second queue.) The gateway periodically inspects the first queue and notifies the mobile device of the presence in the first queue of a new data item (i.e., a data item that was not in the first queue the last time the gateway inspected the first queue).

Preferably, the method also includes receiving an instruction to associate the filter with another mobile device and, upon receiving a data item that is addressed to the other mobile device, notifying the other mobile device of the receipt of the data item only if such notifying is allowed by the filter.

Preferably, the method also includes receiving from the mobile device, in response to the notifying of the receipt of the data item, a request to forward the data item to the mobile device, and, in response to the receipt of that request, forwarding the data item to the mobile device.

Preferably, the filter specifies a plurality of types of data items for which the notifying is to be effected. The filter includes, for each type of data item, an indication of a respective ringtone that the mobile device is to emit upon being notified of the receipt of a data item of that type. As part of the notifying of the mobile device that a data item of a certain type has been received, the mobile device is sent the indication of the respective ringtone of that data item type.

A basic server of the present invention is a server for a computer network that also includes a gateway that couples the computer network to a cellular network. The server includes an interface to the computer network, a filter receipt module and a filter application module. The filler receipt module is for receiving, from the gateway or from elsewhere in the computer network, a filter that is associated with a mobile device of the cellular network. The filter application module applies the filter to (a) data item(s) that is/are received from the computer network and that is/are addressed to the mobile device.

Preferably, the application of the filter to the data item(s) includes putting the data item(s) in a notification queue only if the notifying of the receipt of that/those data item(s) is allowed by the filter. Most preferably, the filter specifies a plurality of types of data items for which the notifying is to be effected. The filter includes, for each type of data item, an indication of a respective ringtone that the mobile device is to emit upon being notified of the receipt of a data item of that type. As part of the notifying of the mobile device that a data item of a certain type has been received, the mobile device is sent the indication of the respective ringtone of that data item type.

Alternatively, the application of the filter to the data item includes sending the mobile device, via the gateway, a notification of the receipt of the data item only if such sending is allowed by the filter. Most preferably, the filter specifies a plurality of types of data items for which the notifying is to be effected. The filter includes, for each type of data item, an indication of a respective ringtone that the mobile device is to emit upon being notified of the receipt of a data item of that type. As part of the notifying of the mobile device that a data item of a certain type has been received, the mobile device is sent the indication of the respective ringtone of that data item type.

One gateway of the present invention interfaces between a cellular network and a computer network that includes a server. The gateway includes an interface to the cellular network, an interface to the computer network, and a push notification module. The push notification module receives from the server, via the interface to the computer network, an identification of a notification queue, at the server, that is associated with a mobile device of the cellular network. The push notification module periodically inspects the notification, queue via the interface to the computer network to determine whether the notification queue includes a new data item, i.e., a data item that was not in the notification queue the last time the push notification module inspected the notification queue. If the notification queue includes such a new data item, the push notification module sends the mobile device, via the interface to the cellular system, a notification of the presence of the new data item at the server.

Another basic gateway of the present invention also interfaces between a cellular network and a computer network. The basic gateway includes an interface to the cellular network, an interface to the computer network and a filter receipt module for receiving, via either interface, a filter associated with a mobile device of the cellular network.

Preferably, the filter receipt module is operative, if the filter is received via the interface to the cellular network, to forward the filter to a server of the computer network via the interface to the computer network.

In one preferred embodiment, the gateway also includes a clock and a push notification module. The clock provides time data such as time of day and/or day of week and/or date. The push notification module receives, via the interface to the computer network, respective notifications of receipt of data items at a server of the computer network. If the filter includes a time reference, the push notification module sends the notifications to the mobile device only if the time data from the clock are consistent with the time reference.

In another preferred embodiment, the gateway also includes a mobile device status module and a push notification module. The mobile device sterns module receives, from the mobile device via the interface to the cellular network, a report of a status of the mobile device. The push notification module receives, via the interface to the computer network, respective notifications of receipt of data items at a server of the computer network. If the filter includes a mobile device status reference, the push notification module sends the notifications to the mobile device only if the status of the mobile device is consistent with the mobile device status reference. Most preferably, the mobile device status includes a location of the mobile device.

### BRIEF DESCRIPTION OF THE DRAWINGS

Various embodiments are herein described, by way of example only, with reference to the accompanying drawings, wherein:

FIG. 1 illustrates the kind of system to which the present invention applies;

FIG. 2 is a high-level partial block diagram of a server of the present invention;

FIG. 3 is a high-level partial block diagram of a gateway of the present invention.

### DESCRIPTION OF THE PREFERRED EMBODIMENTS

The principles and operation of push notification filtering according to the present invention may be better understood with reference to the drawings and the accompanying description.

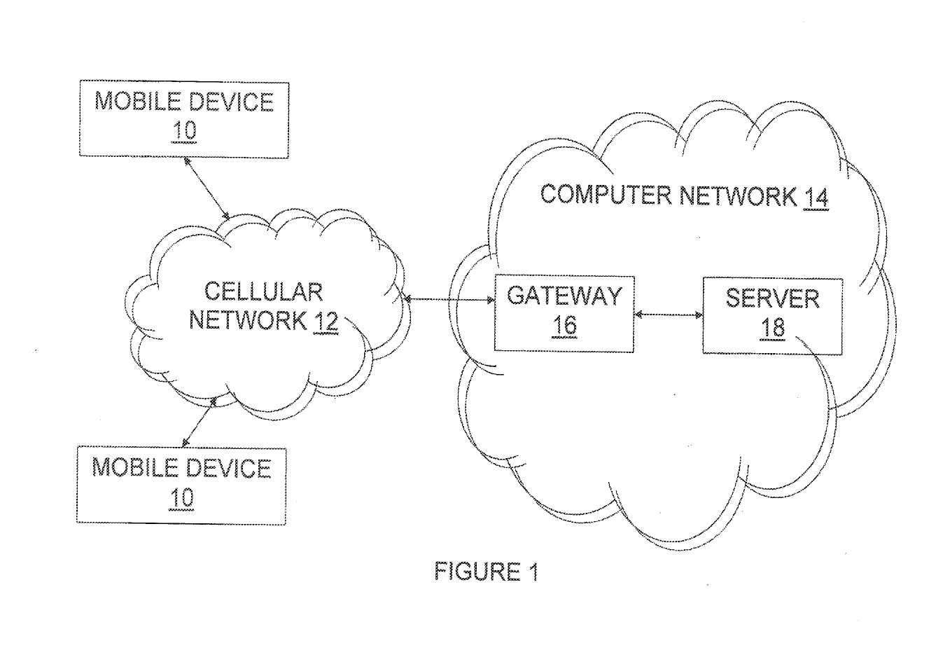

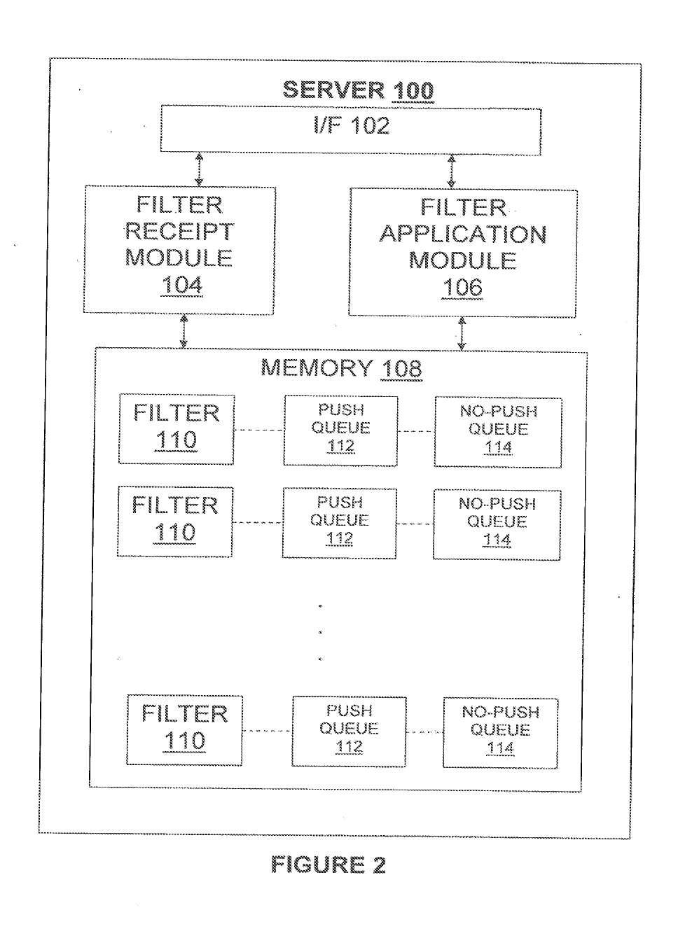

Referring again to the drawings, FIG. 2 is a high-level partial block diagram of a server 100 of the present invention that substitutes for server 18 of FIG. 1. Only the functional blocks of server 100 that are germane to the present invention are illustrated in FIG. 2; server 100 is otherwise conventional. Server 100 includes an interface 102 for exchanging packets with computer network 14, a memory 108 that could be either volatile or nonvolatile but that preferably is nonvolatile, and two functional modules: a filter receipt module 104 and a filter application module 106. Modules 104 and 106 may be implemented as hardware, firmware and/or software. If modules 104 and 106 are implemented as software, they are implemented as executable code that is stored in server 100 in a nonvolatile memory and that is executed by a processor of server 100.

Server 100 also includes a data item handling module (not shown) that receives from computer network 14 data items such as e-mail and calendar items that are destined for mobile devices 10, and that pushes notifications of the receipt of these data items to mobile devices 10 via a gateway of computer network 14, such as gateway 16 or such as gateway 200 discussed below. Notifications for mobile devices 10 with which are associated data item filters 110 of the type discussed below are pushed via gateway 200; other notifications may be pushed via either gateway 200 or via a conventional gateway 16.

Filter receipt module 104 receives data item filters 110 for mobile devices 10 via interface 102. These filters are provided to server 100 by the users of mobile devices 10, either using their mobile devices 10 or using computer equipment such as personal computers that are connected directly to computer network 14. Each filter specifies, for a particular mobile, device 10, criteria for pushing or not pushing data item notifications to that mobile device 10. Exemplary criteria include the following:

Notify receipt of e-mail from only a list of approved senders.

Do not notify receipt of e-mail from a list of blocked senders.

Notify receipt of only e-mail whose subject field includes a word from a list of keywords.

Do not notify receipt of e-mail whose subject field includes a word from a list of keywords.

Notify receipt of only e-mail that is received during certain time intervals.

Notify receipt only of e-mail that is flagged as urgent.

Notify receipt only of e-mail that has, in its recipient list, another recipient who is a member of a set of friendly recipients.

Do not notify receipt of e-mail that has, in its recipient list, another recipient who is a member of a set of hostile recipients.

Those skilled in the art will readily conceive of other criteria and of compound criteria that are logical combinations of simpler criteria. For example, a user of a mobile device 10 may want to receive e-mail notifications between 20:00 and 06:00 only if the sender of the e-mail is his or her boss.

Filter receipt module 104 stores filters 110 in memory 108 and also notifies gateway 200 described below of the receipt of filters 110. When server 100 receives a data item that, according to the prior art, would automatically cause a notification of such receipt to be pushed to a mobile device 10, filter application module 106 checks memory 108 to see whether a filter 110 for that mobile device 10 is stored in memory 108. If such a filter 110 is present in memory 108, then filter application module 106 places the data item in either in a push queue 112 that is associated with that filter 110 and hence with that mobile device 10 or in a no-push queue 114 that is associated with that filter 110 and hence with that mobile device 10. The association of filters 110 with corresponding queues 112 and 114 is represented in FIG. 2 by dashed lines. If a filter 110 for that mobile device 10 is not present in memory 108 then filter application module 106 instructs server 100 to teat the data item according to the prior art, i.e., to just place the data item in a queue (not shown) that is associated with that mobile device 10 and to push to that mobile device 10 a notification of the receipt of that data item.

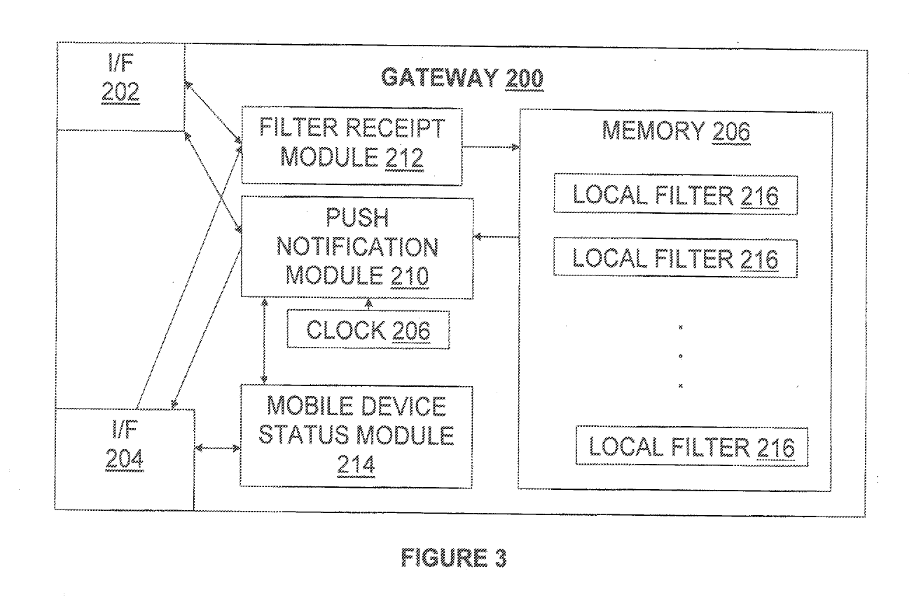

FIG. 3 is a high-level block diagram of a gateway 200 of the present invention that substitutes for gateway 16 of FIG. 1. Only the functional blocks of gateway 200 that are germane to the present invention are illustrated in FIG. 3; gateway 200 is otherwise conventional. Gateway 200 includes an interface 202 for exchanging packets with computer network 14, an interface 204 for communicating with cellular telephony network 12, a memory 206 that could be either volatile or nonvolatile but that preferably is nonvolatile, a clock 208, and three functional modules: a push notification module 210, a filter receipt module 212 and a mobile device status query module 214. Modules 210, 212 and 214 may be implemented as hardware, firmware and/or software. If modules 210, 212 and 214 are implemented as software, they are implemented as executable code that is stored in gateway 200 in a nonvolatile memory and that is executed by a processor of gateway 200.

Filter receipt module 212 receives data item filters for mobile devices 10 via either interface 202 or interface 204. These filters are provided to gateway 200 by the users of mobile devices 10. Typically, if the users provide the filters using their mobile devices 10 then the filters are received via interface 204; and if the users provide the filters using computer equipment such as personal computers that are connected directly to computer network 14, then the filters are received via interface 202. As noted above in the description of server 100, each filter specifies, for a particular mobile device 10, criteria for pushing or not pushing data item notifications to that mobile device 10. Most such criteria are too computationally intensive for gateway 200 to handle, and indeed it is one of the objects of the present invention to offload the handling of such criteria to server 100. The criteria that are too computationally intensive for gateway 200 to handle typically are criteria that are related to data that are stored in the various fields of the data items and that are such that gateway 200 would have to parse the data items in order to retrieve such data. The criteria that are not too computationally intensive for gateway 200 to handle are criteria that do not require parsing of data items and include e.g. criteria related to the time of day, as determined by reference to clock 208, and criteria related to the status of mobile devices 10, as determined by mobile device status query module 214. When filter receipt module 212 receives a filter, filter receipt module 212 reads the filter to determine whether the filter includes criteria that can be handled by gateway 200 (and specifically by push notification module 210). If the filter includes such criteria, filter receipt module 212 stores those criteria in memory 206 in a local filter 216 that is associated with the same mobile device 10 as the filter from which the criteria were extracted. In any case, filter receipt module 212 forwards the filter to server 100 via interface 202.

Push notification module 210 receives from filter receipt module 104, via interface 202, notifications of the receipt by filter receipt module 104 of filters for mobile devices 10. Each such notification includes an identifier of the associated mobile device 10 and an identifier of the associated push queue 112. Periodically, push notification module 210 queries each push queue 112 via interface 202 to determine whether that push queue 112 includes a data item for which a notification has yet to be pushed to the associated mobile device 10. If that push queue 112 includes such a data item, push notification module 210 checks memory 206 to see whether a local filter 216 for that mobile device is present in memory 206. Criteria in local filters 216 override criteria in filters 110, as discussed further below. If such a local filter 216 does not exist, or if such a local filter 216 does exist and its criteria permit pushing notifications to that mobile device 10, than push notification module 210 pushes to that mobile device 10, via interface 204, a notification that the data item has been received, and also sends filter receipt module 104, via interface 202, a request to mark that data item in push queue 112 as “notified”. (Later, when the mobile device 10 downloads its pending data items from the associated queues 112 and 114, those data items will be deleted from those queues).

If a local filter 216 includes a time restriction on when notifications are allowed to be sent to the corresponding mobile device 10, then push notification module 210 checks clock 208 to determine whether pushing the notification is presently allowed, and pushes the notification to that mobile device 10 only if such pushing is presently allowed. If a local filter 216 includes a criterion relating to a status of the corresponding mobile device 10, for example a criterion relating to the present location of that mobile device 10, then push notification module 210 requests mobile device status query module 214 to query that mobile device 10 relative to that criterion. Mobile device status query module 214 queries the mobile device 10 via interface 204 and reports its findings to push notification module 210. Push notification 210 then either pushes the notification or does not push the notification, in accordance with the criterion.

Optionally, filter receipt modules 104 and 212 are configured to associate more than one mobile device 10 with a filter 110 or 216. Specifically, filter receipt modules 104 and 212 are configured to receive, in the same manner as filters 100 and 216 are received, a request from a user of a mobile device 10 to associate that mobile device 10 with an existing filter 110 or 216. This relieves the user of several mobile devices 10 of the burden of having to provide the same filter 110 or 216 separately for each mobile device 10.

Optionally, the criteria defined by filters 110 include indications of what kind of ringtones the associated mobile devices 10 should produce, for example in response to receipt of different kinds of data items. For example, associating different ringtones with e-mail vs. calendar items notifies a user that an incoming notification is of receipt of e-mail vs. receipt of a calendar item. Another example is the use of reveille as a ringtone for notification of the receipt of e-mail whose sender is the user's boss. When a data item is added to a push queue 112, if the criterion that caused the addition of that data item to that push queue 112 includes a ringtone indication, then that ringtone indication is added to the data item.

An alternative embodiment of server 100 does not need to cooperate with gateway 200 but instead can use prior art gateway 16 for selectively pushing notifications of receipt of data items. This alternative embodiment of server 100 does not maintain separate push queues 112 and no-push queues 114, but instead just uses the criteria in filters 110 to either push or not push notifications to the associated mobile devices 10.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A gateway between a cellular network and a computer network that includes a server, the gateway comprising:
(a) an interface to the cellular network;
(b) an interface to the computer network;
(c) a push notification module for:
(i) receiving, from the server via said interface to the computer network, an identifier of a notification queue, at the server, that is associated with a mobile device of the cellular network;
(ii) periodically inspecting said notification queue via the interface to the computer network to determine whether said notification queue includes a new data item; and
(iii) if said notification queue includes said new data item: sending said mobile device, via said interface to the cellular system, a notification of a presence of said new data item at the server.

2. A gateway between a cellular network and a computer network, the gateway comprising:
(a) an interface to the cellular network;
(b) an interface to the computer network; and
(c) a filter receipt module for receiving a filter associated with a mobile device of the cellular network.

3. The gateway of claim 2, wherein said filter receipt module is operative, if said filter is received via said interface to the cellular network, to forward said filter to a server of the computer network via said interface to the computer network.

4. The gateway of claim 2, further comprising:
(d) a clock that provides time data; and
(e) a push notification module for:
(i) receiving, via said interface to the computer network, respective notifications of receipt of data items at a server of the computer network, and
(ii) if said filter includes a time reference, sending said notifications to said mobile device only if said time data are consistent with said time reference.

5. The gateway of claim 2, further comprising:
(d) a mobile device status module for receiving, from said mobile device via said interface to the cellular network, a report of a status of said mobile device; and
(e) a push notification module for:
(i) receiving, via said interface to the computer network, respective notifications of receipt of data items at a server of the computer network, and
(ii) if said filter includes a mobile device status reference, sending said notifications to said mobile device only if said status is consistent with said reference.

6. The gateway of claim 2, wherein said status includes a location of said mobile device.
